(19) United States
(12) Patent Application Publication
(10) Pub. No.: US 2022/0106969 A1
(43) Pub. Date: Apr. 7, 2022

(54) HYDRAULIC UNIT WITH PARALLEL PUMPS LINKED TO A SERVOMOTOR AND USE THEREOF

(71) Applicant: DRAUSUISSE BRASIL COMERCIO E LOCACAO DE UNIDADES HIDRAULICAS INTELIGENTES S.A., Sao Paulo (BR)

(72) Inventor: Ercio Miguel Nema, Sao Paulo (BR)

(21) Appl. No.: 17/290,056

(22) PCT Filed: Oct. 29, 2019
(86) PCT No.: PCT/BR2019/000037

§ 371 Date: Apr. 29, 2021

(30) Foreign Application Priority Data
Nov. 14, 2018 (BR) 102018735390

(51) Int. Cl. F15B 1/04; F15B 13/02; F15B 1/26; F15B 15/18

(52) U.S. Cl. CPC F15B 1/04; F15B 15/18; F15B 1/26; F15B 13/027

(57) ABSTRACT

A hydraulic unit is provided that includes a ball screw, which is driven by a servomotor, and both are configured to raise and lower two hydraulic sleeves of two hydraulic piston pumps, mounted in parallel and separately from one another. This is to draw hydraulic oil from an oil reservoir and pump this pressurized oil into one or more hydraulic pressure accumulators. When the hydraulic pressure accumulators are full, there can be an increase in hydraulic pressure activating a pressure sensor that can control the halting of the servomotor.

### INTRODUCTION

The present patent of invention relates to a hydraulic unit, with compact dimensions, with a capacity to serve various applications, prominently the use of a low-power servomotor, coupled to a ball screw which, jointly, perform alternative rotational movements in the direction of movement of the plunger of a piston pump, right and left, up and down, such that, with said movements, it is possible to draw/pump the oil, which has a certain volume displaced under a certain pressure in each movement performed.

### FIELD OF APPLICATION

The field of application of the present invention focuses on the movement of hydraulic actuators in the most part of machines and equipment that operate with hydraulic oil.

### BACKGROUND OF THE ART

Conventional hydraulic units have a very specific function, which, for the most part, conventional electric motors are used to activate the hydraulic pump, which continuously pumps the oil drawn from a large reservoir to be used to move hydraulic actuators and, when these actuators are idle, the oil continues to be pumped; in this condition, this oil, which is not used to move the actuators, is directed back to the reservoir continuously, performing what is known as “venting”.

Persons skilled in the art are aware that conventional hydraulic units boost and control a certain force, which easily enables the control and movement of hydraulic actuators and which present specific functions for industrial machinery, such as, for example, presses, and also power generation, mining and steel industry equipment.

### Problems to be Solved

Below is a list of some limitations of conventional hydraulic units:

Consumption of electric energy—in the conventional models, electric motors work in a constant regime, driving at least one hydraulic pump that sends oil to the system on a continuous basis and, when the hydraulic actuators are idle, without carrying out any movement, the oil coming from the pump is diverted back to the oil reservoir, through a valve, either directional or safety, and this wasted oil consumes electric energy that is not being used to perform work.

Generation of heat—the attrition of the oil passing through the valves returning to the oil reservoir generates heat and, when they return to the reservoir, are pumped again, in a recirculation system, and the very movement of suction and compression of the oil in pumping also generate heat.

Generation of noise—the attrition in the metal-to-metal contact in the moving parts of the pumps, be they Pistons, Vanes, Bolts or Gear, generates noise which, when repeated in the frequency of the rotation of the electric motor, may attain high levels that are harmful to the hearing, obliging users to use ear protectors.

Use of pumps whose moving parts frequently touch—the metal-to-metal contact touching in the current pump models, be they Piston, Vanes, Bolt or Gear, cause an increase in the clearance that already exists between these mobile components, generating a loss of pressure and releasing solid particles that come away from the metal parts by the process of wear, and these particles are highly harmful to the proper working of the hydraulic directional valves.

Leakage—in the piston pumps, there is clearance between the axis and the hole of the pistons, normal in the design, to enable the displacement thereof. This clearance in new pumps represents a loss of 15% in hydraulic pressure and also in oil leakage which, over time, has this clearance increased by wear and, consequently, the deficiency of the pumping increases, until it reaches a point wherein the working pressure cannot be attained because of the leakage existing in the clearance between the axis and the hole, to the extent of no longer satisfying the need of the application, requiring repairs, which also occurs with Vane, Gear and Bolt pumps.

Locking—the release of metal particles arising from the attrition between the moving parts of the pumps, may cause the locking of the hydraulic directional valves, chiefly in the proportional valves that act with greater precision in its positioning. As already commented upon, these metal particles are released by virtue of the constant attrition of the moving parts of the pumps, chiefly in the Piston, Vane, Gear or Bolt pumps, which are necessary and inevitable due to their constructive design.

### State of the Art

The current state of the art anticipates some patent documents which refer to the subject matter in question, such as U.S. Pat. No. 5,261,810A, filed on Sep. 16, 1992 and published on Nov. 16, 1993, entitled “CLOSING AND CLEANING SYSTEM”, which consists of a ball screw that activates the axial forward and backward movement of a hydraulic plunger, mounted on the same axial axis, which has the function of suctioning and pumping oil.

The document cited above acts as a piston pump, which comprises a plunger with through-rod on the two faces, and one of these is fixed to the bolt of the ball screw, being only for pumping the oil.

The other document, U.S. Pat. No. 6,079,797A, filed on Feb. 12, 1999 and published on Jun. 27, 2000 entitled, “DUAL ACTION BALL SCREW PUMP”, which has a different mechanical construction to the previous one, but, in the same manner, is comprised of a ball screw that is mounted on the same axial axis, with just one piston, which moves according to the rotation of the ball screw.

The above document describes a system that functions as a piston pump, composed of the ball screw bolt, which is fixed at one end of the piston rod and, when the ball rotates, which occurs in both directions, the piston also moves in the axial direction, performing the suction work of oil and pumping, and the whole assembly is aligned on the same axis.

### Objectives of the Invention

It is an objective of the present invention to propose a hydraulic unit with parallel hydraulic pumps, which operates jointly with a servomotor interlinked to the pumps by a ball screw, which makes the hydraulic unit economical and compact.

It is an objective of the present invention to propose a hydraulic unit capable of significantly economizing the consumption of electric energy which, in some cases, may amount to savings of 90%, compared to conventional systems.

It is an objective of the present invention to propose a hydraulic unit that uses hydraulic pressure accumulators as an integral part of the system to act as an element for guaranteeing the continuous supply of oil. It is thus possible to eliminate the system of venting the oil, that is, in this invention, when the hydraulic actuators are idle, a pressure sensor will record an increase in pressure in the system and the servomotor will stop working to interrupt the oil pumping to prevent the safety valve from opening to divert the oil returning to the reservoir, circulating dry, generating oil heating, as occurs in conventional systems.

It is an objective of the present invention to propose a hydraulic unit capable of generating four different pressures, without the need to alter the electronic standards of the equipment.

It is an objective of the present invention to propose a hydraulic unit which, in operating immersed in the oil reservoir, prevents leakages.

It is an objective of the present invention to propose a hydraulic unit whose two pumps operate with mobile sleeves in the respective hydraulic rods.

It is an objective of the present invention to propose a hydraulic unit capable of reducing noise, performing the work of oil pumping in a silent manner, significantly reducing noise, when compared to current systems.

It is an objective of the present invention to propose a hydraulic unit capable of drastically reducing the volume of oil from the oil reservoir by up to 80% in relation to the conventional system.

It is an objective of the present invention to propose a hydraulic unit capable of reducing the physical space of the set in relation to current systems.

It is an objective of the present invention to propose a hydraulic unit capable of separating the mobile metal parts, which move, using permanent self-lubricating sealing and bearing elements.

### SUMMARY OF THE INVENTION

The working of the hydraulic unit claimed is based on the rotation of a ball screw, in both directions, driven by a servomotor. The hydraulic unit is constituted by two hydraulic pumps, mounted outside the axial axis of the ball screw, said pumps being mounted in parallel to each other, having a third central axis between them, which is the ball screw that has its bolt inserted in a part, which is fixed on the hydraulic sleeves of the two hydraulic pumps, which move up and down to perform the work of pumping. The work of pumping consists of drawing the oil from the reservoir to fill a hydraulic chamber, whereas the oil from the other chamber is being pumped, and at the end of the displacement stroke the reversal of the movement occurs, which an important difference, which is the rod or the pump piston which, instead of moving, is fixed and static, and what moves it are the hydraulic sleeves of the pumps, performing the suction and pumping work under pressure.

### Advantages of the Invention

In short, the present invention presents the following most prominent advantages:

Versatility—smart equipment that provides just the oil volume needed to carry out that movement, resulting in significant savings in electric energy.

Savings—savings of up to 90% in electric energy compared to conventional hydraulic units.

Thermo-acoustic comfort.

Sustainability—Reduction of up to 90% of oil volume of the reservoir.

Independence—it does not need auxiliary equipment for cooling the hydraulic oil. It reduces and stabilizes the temperature of the hydraulic oil.

### DESCRIPTION OF THE DRAWINGS

The invention will now be described in terms of an embodiment, and for improved understanding, references will be made to the accompanying drawings, in which the following are represented:

FIG. 1: Sectional view of the hydraulic unit with parallel pumps linked to the servomotor;

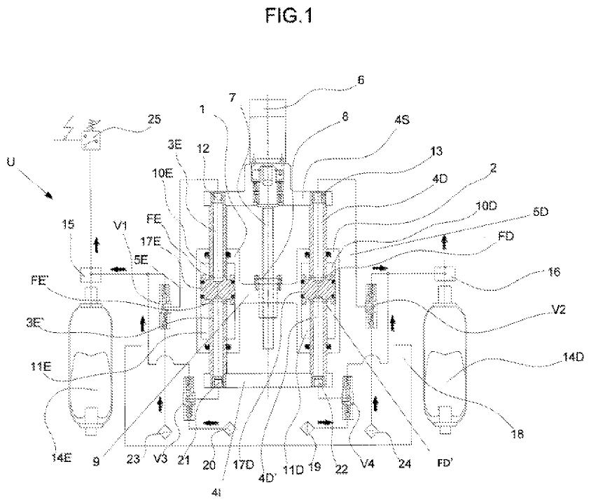

FIG. 2: Enlarged detail of the link of the ball screw to the part linking to the pumps.

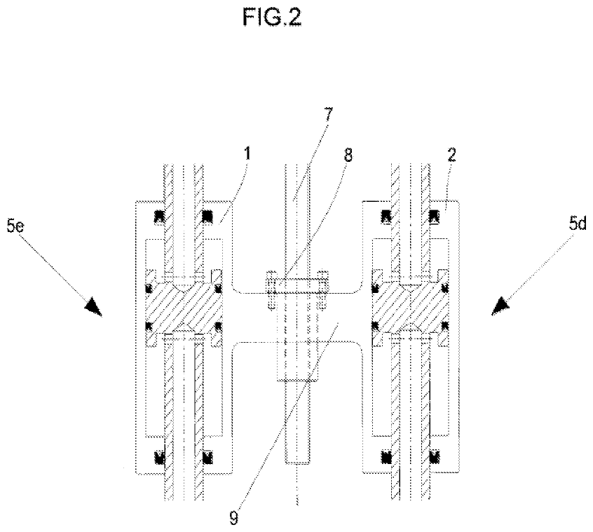

### DETAILED TECHNICAL DESCRIPTION OF THE INVENTION

A HYDRAULIC UNIT WITH PARALLEL PUMPS LINKED TO THE SERVOMOTOR relates to a multifunctional hydraulic unit (U), comprised of two hydraulic pumps (1 and 2) mounted in parallel, and can be classified as piston pumps with a major innovative difference, as the pistons represented by the hydraulic rods (3E and 3E′, 4D and 4D′) are static, fixed on roller bearing (4S) and on the base (41), and what moves to perform the pumping are the hydraulic sleeves (5E and 5D) of the hydraulic pumps (1 and 2). The working occurs as follows: the servomotor (6) is coupled on a roller bearing (4S) which has the ball screw (7) coupled on the other face, with the function of displacing the bolt (8) of the ball screw (7) upwardly or downwardly, according to the rotation direction of the servomotor (6). When the ball screw (7) is turning clockwise, for example, the bolt (8) of the ball screw (7) which is coupled and fixed on a connecting part (9) between the two hydraulic pumps (1 and 2), begins to be displaced upwards, taking with it the hydraulic sleeves (5E and 5D) of the two hydraulic pumps (1 and 2) which, as already mentioned, are interlinked to each other through this connecting part (9).

Therefore, the hydraulic sleeves (5E and 5D) of the hydraulic pumps (1 and 2) slide on the hydraulic rods (3E and 3E′, 4D and 4D′), which are static and fixed on the roller bearing (4S) and on the base (41). When the hydraulic sleeves (5E and 5D) of the hydraulic pumps (1 and 2) begin to rise, the oil that is idle in the lower hydraulic chamber (11E and 11D) begins to be pressured and starts to move outwardly, passing first through the oil passage hole (FE′ and FD′) of the lower hydraulic chamber (11E and 11D), passing through the lower hydraulic rod (3E′ and 4D′) exiting through the hole (21 and 22) opening the lower check valve (V3 and V4) and passing through it to be stored in the hydraulic pressure accumulators (14E and 14D), where it will remain idle and ready to be used, when necessary, by means of the manifold block (15 and 16).

In the same upward movement, while the hydraulic oil is being displaced into the hydraulic pressure accumulators (14E and 14D), oil from the upper hydraulic chamber (10E and 10D) is being filled simultaneously, by means of a suction generated by the hydraulic plunger (17E and 17D) of the hydraulic pump (1 and 2), which draws the oil from the oil reservoir (18) passing through the suction filter (23 and 24) which force the opening of the upper check valve (VI and V2), passing through the hole (13 and 14), where it is led through the inside of the upper hydraulic rod (3E and 4D), subsequently arriving at the upper hydraulic chamber (10E and 10D), remaining idle.

Upon arriving at the end of the displacement stroke of the hydraulic sleeve (5E and 5D) of the hydraulic pumps (1 and 2), still in the upward movement, an electronic command is given and inversion occurs in the rotation direction of the servomotor (6), meaning the ball screw (7) begins to turn in the opposite direction, that is, counter-clockwise, displacing the bolt (8) of the ball screw (7) downward and taking with it the two hydraulic pumps (1 and 2), which now being to compress the oil which was idle in the upper hydraulic chamber (10E and 10D), meaning it is led to the oil passage hole (FE and FD) of the upper hydraulic chamber (10E and 10D), passing through the inside of the upper hydraulic rod (3E and 4D) and exiting through the hole (12 and 13), forcing the opening of the upper check valve (VI and V2) and storing inside the hydraulic pressure accumulators (14E and 14D), remaining idle and ready to be used, when necessary, by means of the manifold block (15 and 16).

During the descent of the hydraulic pumps (1 and 2), the oil begins to fill the lower hydraulic chamber (11E and 11D), by means of the suction performed by the hydraulic plunger (17E and 17D), which draws the oil passing through the suction filter (19 and 20), forcing the opening of the lower check valve (V3 and V4) which pushes the oil from the oil reservoir (18), passing through the hole (21 and 22) of the lower hydraulic chamber (11E and 11D), being led through the lower hydraulic rod (3E′ and 4D′) and arriving at the lower hydraulic chamber (11E and 11D), passing through the oil passage hole (FE′ and FD′), entering into a continuous pumping regime.

When the hydraulic pressure accumulators (14E and 14D) are full, there will be an increase in hydraulic pressure, which will activate the pressure sensor (25) which will control the halting of the servomotor (6) and, consequently, it will stop pumping, keeping the system on-hold.

At the time where one of the actuators, of the machine that will use this invention, moves, there will be a minor drop in internal pressure of the hydraulic pressure accumulators (14E and 14D), and the pressure sensor (25) will automatically control the immediate working of the hydraulic pump (1 and 2), which will instantly replace the volume of oil that was used. If the actuators used no oil, then the hydraulic pumps (1 and 2) will remain idle, but keeping the entire system pressurized.

This invention also enables four different hydraulic pressures to be produced simultaneously, two pressures in the upward movement and two pressures in the downward movement.

Producing four different pressures, without altering the electronic parameters of the equipment, is possible because the two hydraulic sleeves (5E and 5D), despite having the same internal diameter, may have the diameters of the hydraulic rods (3E and 3E′, 4D and 4D′) that are different to each other, that is to say, different areas in the upper hydraulic chamber (10E and 10D) and in the lower hydraulic chamber (11E and 11D) which, receiving the same force, will result in different pressures and, in this case, each hydraulic chamber (10E, 10D, 11E, 11D) may be linked to its own hydraulic pressure accumulator (14E and 14D), which enables greater flexibility and versatility to this invention.

1-9. (canceled)

10. A hydraulic unit with parallel pumps linked to the servomotor characterized by comprising:
a first hydraulic pump comprising a hydraulic sleeve, an upper hydraulic chamber, a lower hydraulic chamber, a plunger, two hydraulic rods, a hydraulic pressure accumulator and a plunger;
a second hydraulic pump comprising a hydraulic sleeve, an upper hydraulic chamber, a lower hydraulic chamber, a plunger, two hydraulic rods, a hydraulic pressure accumulator and a plunger;
a servomotor, coupled to a roller bearing that has a ball screw coupled on the other face;
a pressure sensor;
a reservoir;
an upper check valve;
a lower check valve;
a suction filter;
wherein the two hydraulic pumps mounted in parallel work jointly with the servomotor; and
wherein the ball screw has the function of displacing the bolt of the ball screw upwardly or downwardly, according to the rotation direction of the servomotor.

11. The hydraulic unit according to claim 10, characterized in that the hydraulic rods are static, fixed on the roller bearing and on a base.

12. The hydraulic unit according to claim 10, characterized in that the hydraulic sleeves of the hydraulic pumps move to perform the pumping.

13. The hydraulic unit according to claim 10, characterized in that optionally the hydraulic rods have different diameters producing four different pressures.

14. The hydraulic unit according to claim 10, characterized by working immersed in the oil.

15. The hydraulic unit according to claim 10, characterized in that the hydraulic pressure accumulators act as an element for guaranteeing the continuous supply of oil to eliminate interruption of the oil flow during the reversal of the movement.

16. The hydraulic unit according to claim 10, characterized in that it is for moving the hydraulic actuators that operate with hydraulic oil.

17. The hydraulic unit according to claim 16, characterized in that up to 90% of the volume of oil from the reservoir is reduced.

18. The hydraulic unit according to claim 17, characterized by generating savings of up to 90% in electric energy.
